(19) United States
(12) Patent Application Publication
(10) Pub. No.: US 2008/0019417 A1
(43) Pub. Date: Jan. 24, 2008

(54) Mobile storage apparatus with temperature detecting function

(75) Inventors: Ming-Ke Chen, Shenzhen (CN); Xiao-Zhu Chen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD.

(21) Appl. No.: 11/586,972

(22) Filed: Oct. 26, 2006

(30) Foreign Application Priority Data
Jul. 21, 2006 (CN) 200620017071.3

(51) Int. Cl. G01K 13/00

(52) U.S. Cl. 374/141

(57) ABSTRACT

A mobile storage apparatus with a temperature detecting function is provided. The mobile storage apparatus includes a shell, a universal serial bus (USB) interface arranged at an end of the shell, and a temperature measuring device. The temperature measuring device includes a temperature sensor, a chip mounted in the shell, and a display module disposed on a top of the shell. The temperature sensor senses a temperature, and converts an analog signal of the sensed temperature into a digital signal. The chip receives the digital signal and converts the digital signal into a display signal. The display module receives the display signal for displaying the sensed temperature.

### BACKGROUND

1. Field of the Invention

The present invention relates to mobile storage apparatus with a temperature detecting function, and particularly relates to a mobile storage apparatus such as a flash disk that is capable of measuring a temperature of a human body or the immediate surroundings.

2. General Background

Many varieties of mobile storage apparatus, such as flash disks and mobile hard disks haves been produced with the development of science and technology.

MP3 playing function, voice recording function and so on have been added to conventional mobile storage apparatus. However, conventional mobile storage apparatus do not have the temperature detecting function, which can add additional value to the mobile storage apparatus and attract customer's attention.

What is needed is a mobile storage apparatus with a temperature detecting function.

### SUMMARY

An exemplary mobile storage apparatus with a temperature detecting function is provided. The mobile storage apparatus includes a shell, a universal serial bus (USB) interface arranged at an end of the shell, and a temperature measuring device. The temperature measuring device includes a temperature sensor, a chip mounted in the shell, and a display module disposed on a top of the shell. The temperature sensor senses a temperature, and converts an analog signal of the sensed temperature into a digital signal. The chip receives the digital signal and converts the digital signal into a display signal. The display module receives the display signal for displaying the sensed temperature.

Other advantages and novel features will become more apparent from the following detailed description when taken in conjunction with the accompanying drawing, in which:

### BRIEF DESCRIPTION OF THE DRAWINGS

FIG. 1 is an isometric view of a mobile storage apparatus with a temperature detecting function in accordance with a preferred embodiment of the present invention; and

FIG. 2 is a block diagram of the mobile storage apparatus of FIG. 1; and

FIG. 3 is a circuit diagram of the mobile storage apparatus of FIG. 1.

### DETAILED DESCRIPTION OF THE EMBODIMENT

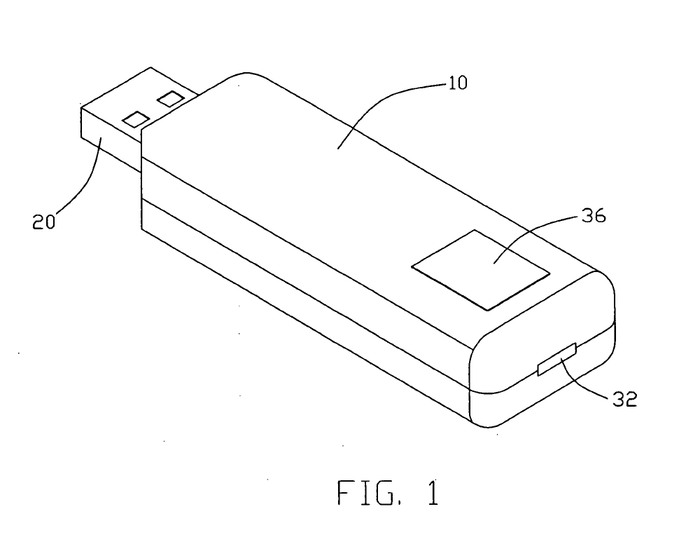

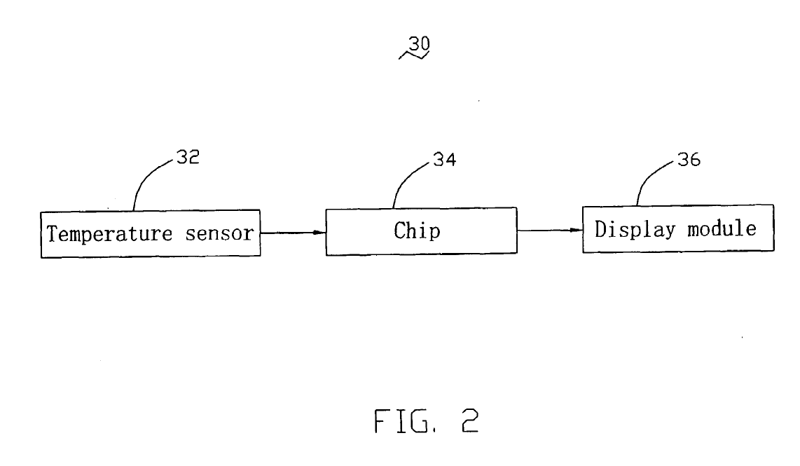

Referring to FIGS. 1 and 2, a mobile storage apparatus (the present invention uses a flash disk as an example) with a temperature detecting function in accordance with a preferred embodiment of the present invention is shown. The mobile storage apparatus includes a shell 10, a universal serial bus (USB) interface 20, and a temperature measuring device 30.

The temperature measuring device 30 includes a temperature sensor 32 mounted at an end of the shell 10, a chip 34 mounted within the shell 10, and a display module 36 disposed on a top of the shell 10.

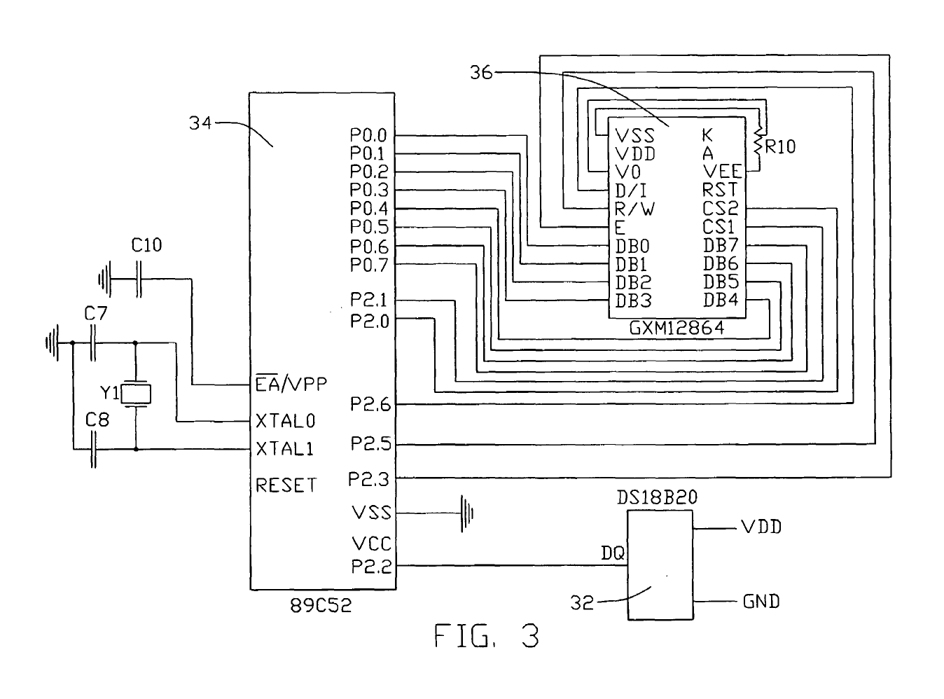

Referring also to FIG. 3, in this embodiment, the temperature sensor 32 is a single in-line, intellective sensor DS18B20 which is made by American DALLAS company. The temperature sensor 32 has 3 pins, including a DQ pin, a VDD pin, and a GND pin. The DQ pin is an output port for outputting signals, the VDD pin is an external power port for connecting to a +5V power source, and the GND pin is grounded. The temperature sensor 32 also can be provided with power by a pull-up resistor when a bus signal on the DQ pin is at a high level. That is, the temperature sensor 32 can work in a parasitical power state without external power, drawing its power from a power source of the mobile storage device.

The chip 34 is a microprocessor 89C52 which is made by American ATMEI company. The chip 34 is packaged with 40-pin Dual In-line. The chip 34 includes P0.0-0.7 pins, P2.0-2.3 pins, a P2.5 pin, a P2.6 pin, a VCC pin, a VSS pin, an E̅A̅/VPP pin, an XTAL0 pin, an XTAL1 pin, and a RESET pin. In the chip 34, the P0.0-0.7 pins are used as data output ports, the VCC pin is connected to an external power source, the VSS pin is grounded to power ground, and the P2.2 pin is used as a data input port. The E̅A̅/VPP pin is an external access enable port, when the E̅A̅/VPP pin is connected to a low level signal, the chip 34 can be accessed and is programmable. The XTAL0 pin and the XTAL1 pin are connected with a clocking circuit consisting of a crystal oscillator Y1, and two capacitors C7 and C8. The clocking circuit is used for providing working clock signals according to need. The RESET pin is a reset port.

The display module 36 is a GXM12864 dot pattern liquid-crystal display (LCD) which is made by Chinese Nanjing Guoxian Electronics Corporation. The display module 36 includes DB0-DB7 pins, a VDD pin, a K pin, an A pin, a VEE pin, a VSS pin, a V0 pin, a CS1 pin, a CS2 pin, a D/I pin, an R/W pin, an E pin, and an RST pin. The DB0-DB7 pins are connected to the P0.0-0.7 pins of the chip 34 respectively. The VDD pin is used for connecting to an external power source. The K pin and the A pin are connected to a back light power source, and the VEE pin is connected to a liquid crystal drive power source. The VEE pin is also connected to the VSS pin of the display module 36 via a rheostat R10. The V0 pin is connected to a tap of the rheostat R10 for contrast control. The CS1 pin and the CS2 pin are chip selection ports connected to the P2.1 pin and the P2.0 pin of the chip 34 respectively The D/I pin and the R/W pin are connected to the P2.6 pin and the P2.5 pin of the chip 34 respectively. The E pin is a signal-enable port, which is connected to the P2.3 pin of the chip 34. The RST pin is a reset port.

When the USB interface 20 of the flash disk is connected to a computer or other electric equipment having USB interfaces, the VCC pin of the chip 34 and the VDD pin of the display module 36 are provided with a +5V direct current power. That is, the chip 34 and the display module 36 are supplied with power via the USB interface 20.

The temperature sensor 32 senses a temperature of human body or the immediate surroundings, and converts an analog signal of the sensed temperature into a digital signal. The temperature sensor 32 transmits the digital signal serially to the P2.2 pin of the chip 34 via the DQ pin of the temperature sensor 32. The chip 34 transforms the digital signal into a display signal and transmits the display signal to the DB0-DB7 pins of the display module 36 via the P0.0-0.7 pins of the chip 34. Then the display module 36 displays the temperature sensed by the temperature sensor 32. A user can check their body temperature or other object by placing the sensor 32 directly against their skin or a surface of the object. When the sensor 32 is not in direct contact with an object a temperature of the immediate environment is sensed.

The mobile storage apparatus with a temperature detecting function in accordance with the preferred embodiment can detect a temperature of a human body or of the immediate surroundings, and furthermore display the temperature, which adds value to the mobile storage apparatus.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A mobile storage apparatus with a temperature detecting function, the mobile storage apparatus comprising:
a shell;
a universal serial bus (USB) interface arranged at an end of the shell and configured to connect with an electric device; and a temperature measuring device including a temperature sensor, a chip mounted in the shell, and a display module disposed on an outer surface of the shell, the temperature sensor acting as sensing a temperature therearound, and converting an analog signal of the sensed temperature into a digital signal, the chip acting as receiving the digital signal and converting the digital signal into a display signal, the display module acting as receiving the digital signal for displaying the sensed temperature.

2. The mobile storage apparatus as claimed in claim 1, wherein the temperature sensor is mounted at an end of the shell.

3. The mobile storage apparatus as claimed in claim 1, wherein the chip and the display module are provided with power via the USB interface.

4. The mobile storage apparatus as claimed in claim 1, wherein the temperature sensor is a single in-line, intellective sensor.

5. The mobile storage apparatus as claimed in claim 4, wherein the temperature sensor works in a parasitical power state when having no external power.

6. A mobile storage apparatus with a temperature detecting function, the mobile storage apparatus comprising:
a temperature sensor for sensing a temperature, and converting an analog signal of the sensed temperature into a digital signal;
a chip electrically connected to the temperature sensor for converting the digital signal into a display signal;
a displaying module electrically connected to the chip for receiving the display signal and displaying the sensed temperature; and
a universal serial bus (USB) interface for providing power to the chip and the displaying module.

7. The mobile storage apparatus as claimed in claim 6, wherein the temperature sensor is a single in-line, intellective sensor.

8. The mobile storage apparatus as claimed in claim 7, wherein the temperature sensor works in a parasitical power state when having no external power.
